(19) United States
(12) Patent Application Publication
(10) Pub. No.: US 2009/0314124 A1
(43) Pub. Date: Dec. 24, 2009

(54) Non-Cylinder Shear Jack Handle and Elastic Connecting Device

(75) Inventors: Yi Zhou, Jiangsu (CN); Youyuan Chen, Jiangsu (CN); Xianqing Li, Jiangsu (CN)

Correspondence Address: LADAS & PARRY, 5670 WILSHIRE BOULEVARD, SUITE 2100, LOS ANGELES, CA, 90036-5679, US

(73) Assignee: ChangShu TongRun Auto Accessory Co., Ltd., Jiangsu (CN)

(21) Appl. No.: 12/368,699

(22) Filed: Feb. 10, 2009

(30) Foreign Application Priority Data
Jun. 20, 2008 (CN) 200810123054.1

(51) Int. Cl. G05G 1/10

(52) U.S. Cl. 74/543

(57) ABSTRACT

This inventions involves a type of multi-node operating handle and elastic connecting device for non-cylinder shear jack; the front node handle is provided with two perforated holes used for locking of pin to facilitate the axle and hole coordination; the rear node handle is provided with three prefabricated holes for rivet joint, which makes use of two rivets to realize the serial connection of elastic metal sheet with locking pin and rear node handle as well as the pressing rivet joint of rivets; furthermore, both front and rear node handles have non-cylinder coordination available for better transfer of torsion moment, which can be used to shape the locking pin on the body of elastic metal sheet through pressing. Favorable effects of this invention are stated as follows: the handle structure and connecting device as described in this proposal can facilitate the length combination of operating handle in accommodation with lifting under different loads, which can ensure the reliability of the handle in use. Furthermore, it is also easy for retraction after use.

### TECHNICAL FIELD

This invention involves a type of operating handle for mechanical jack, especially a type of multi-node operating handle and elastic connecting device for non-cylinder shear jack.

### BACKGROUND TECHNOLOGY

Existing operating handle for screw shear jack normally requires appropriate distance between operators and vehicles or heavy goods lifted by the jack, which would provide certain torsion moment for the rotation of screw when lifting heavy goods. Moreover, operating force as required by generation of this type of torsion moment is determined by the handle length. Therefore, the single-node handle is normally made longer. Mechanical connection between front and rear handles is not quick and convenient enough, and the strength of handle joint is also inadequate at the time of transfer of torsion moment despite of the fact that some handles are connected in several nodes. In particular, the integrated long handle is inconvenient for storage by users after use.

### SUMMARY OF INVENTION

This invention aims to overcome existing technical defects to provide a type of operating handle equipped with elastic connecting device, which can facilitate either the connection of non-cylinder multi-node handle to satisfy the transfer of torsion moment or the retraction of handle after use.

Aforesaid purposes of this invention are realized by the following technical proposal: a type of multi-node operating handle and elastic connecting device for non-cylinder shear jack, including front node handle, rear node handle and locking pin, has the following features: the front node handle is provided with two perforated holes used for locking of pin to facilitate the axle and hole coordination; the rear node handle is provided with three prefabricated holes for rivet joint, which makes use of two rivets to realize the serial connection of elastic metal sheet with locking pin and rear node handle as well as the pressing rivet joint of rivets; furthermore, both front and rear node handles have non-cylinder coordination available for better transfer of torsion moment, which can be used to shape the locking pin on the body of elastic metal sheet through pressing.

As compared with existing technologies, this invention has the following favorable effects: the non-cylinder front and rear node handles with axle and hole coordination and elastic connecting device as described in this proposal can facilitate the length combination of operating handle in accommodation with lifting under different loads, which can ensure the reliability of the handle in use and the mechanical strength as required by transfer of torsion moment. Furthermore, it is also easy for retraction after use with its small volume and light weight.

### ILLUSTRATION OF ATTACHED DRAWINGS

Illustration of attached drawings for empirical examples:

FIG. 1: diagram showing operating status of front and rear node handles of this invention

FIG. 2: A-A section of this invention as shown on FIG. 1

FIG. 3: diagram showing the position of locking pin when the elastic metal sheet 3 as indicated on A-A section of this invention is pressed

FIG. 4: diagram showing the status at which profile of rear node handle forms moving pair with chamber surface of front node handle to retract the rear node handle into the front node handle

FIG. 5: diagram showing the locked state of locking pin 6 penetrated into the coordinating hole 4

FIG. 6: diagram showing 3D status of elastic metal sheet 3

FIG. 7: general view of elastic metal sheet as indicated on FIG. 6

FIG. 8: left view of FIG. 7

FIG. 9: planform of FIG. 7

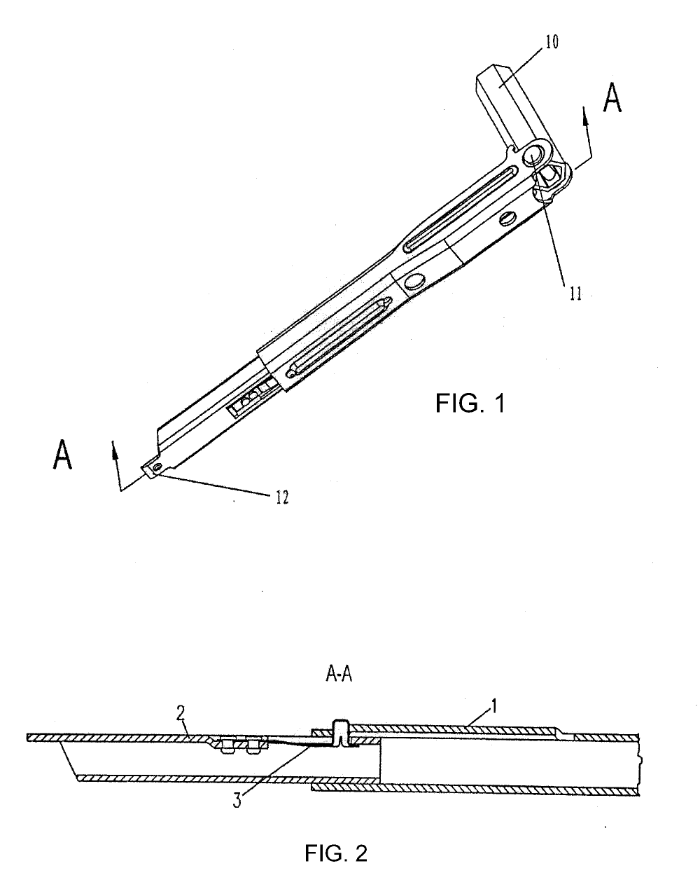

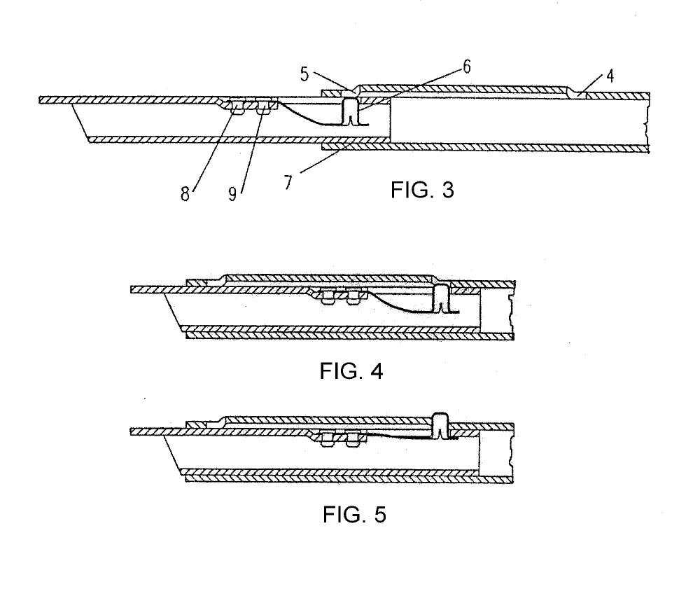

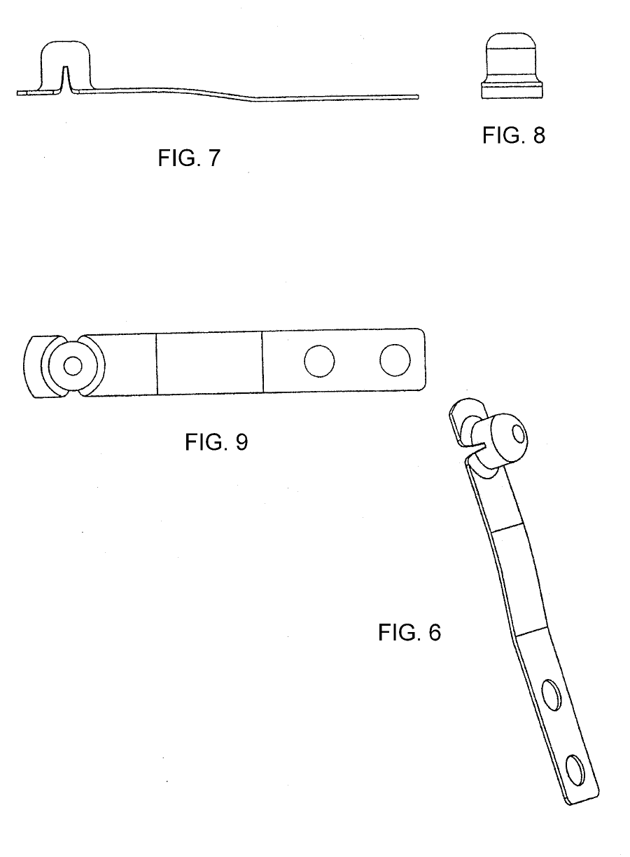

### DESIGNATIONS OF AFORESAID DRAWINGS ARE STATED AS FOLLOWS

1 front node handle; 2 rear node handle; 3 elastic metal sheet; 4 coordinating hole; 5 coordinating hole; 6 locking pin; 7 moving pair; 8 rivet; 9 rivet; 10 hexagon sleeve; 11 revolute pair; 12 tire prying flange

### Specific Implementation Modes

Further description of this invention in combination with empirical examples is helpful to the understanding of technical contents and effects of this invention.

As indicated on attached drawings, one end of hexagon sleeve 10 connected to the end of jack screw of this type of integrated jack operating handle is in rotating linkage with front handle through moving pair 11; it has three functions: firstly, it can be used as the labor saving lever to turn the screw of shear jack to realize the lifting of vehicles and heavy goods; secondly, it can be attached with locking bolt or nut for disassembly of wheel; thirdly, it can make use of the tire prying flange 12 to facilitate the disassembly of tire. The hexagon sleeve 10 can rotate to the shaped chamber of front node handle under the action of revolute pair 11; coordinating holes 4 and 5 are provided at the appropriate position of front node handle; left end of elastic metal sheet 3 is positioned to the rear node handle 2 with rivets; the locking pin 6 is shaped through integrated pressing on the elastic metal sheet 3; As required by the transfer of torsion moment, both front and rear node handles are fabricated into non-cylinder structure to facilitate the tire prying flange 12 to pry the tire edge or realize the transfer of specific torsion moment when the hexagon sleeve 10 is in a “linear” orientation with central line of front and rear node handles for the purpose of disassembling bolts and nuts.

Elastic connecting device of this invention is operated as follows: as indicated on FIG. 5, 4, 3 and 2, press the locking pin 6 to the extent that rear node handle can perform axial movement before pulling the rear node handle 2 to the position where locking pin 6 and coordinating hole 5 of front node handle are on the same axis, and making slight adjustment until the locking pin 6 slips into the coordinating hole 5; rotate the hexagon sleeve 10 at the front part of the handle around the revolute axle until its axis is vertical to that of the handle; it is applicable to impose force on handle to rotate the hexagon sleeve 10 to transfer torsion to the jack screw by covering the hexagon head on the screw end of the jack with head of hexagon sleeve 10; once completed, the hexagon sleeve would be screwed on the shaped chamber of front node handle 1 under the action of revolute pair 11 to press the locking pin 6 for the purpose of retracting the rear node handle into the shaped chamber of front node handle 1, and facilitating the locking pin 6 to slip into the coordinating hole 4 simultaneously.

1. A type of multi-node operating handle and elastic connecting device for non-cylinder shear jack, including front node handle, rear node handle and locking pin, which has the following features: the front node handle (1) is provided with two perforated holes (4) and (5) used for locking of pin to facilitate the axle and hole coordination; the rear node handle (2) is provided with two prefabricated holes for rivet joint, which makes use of two rivets (8) and (9) to realize the serial connection of elastic metal sheet (3) with locking pin and rear node handle (2) as well as the pressing rivet joint of rivets;

2. According to claim 1, a type of non-cylinder shear jack handle and elastic connecting device also has the following features: locking pin (6) is shaped on the elastic metal sheet (3) through pressing.

3. According to claim 1, a type of non-cylinder shear jack handle and elastic connecting device also has the following features: front node handle (1) and rear node handle (2) are fabricated into non-cylinder shape.
